(19) United States
(12) Patent Application Publication
(10) Pub. No.: US 2026/0016223 A1
(43) Pub. Date: Jan. 15, 2026

(54) WATER PURIFIER

(71) Applicant: COWAY Co., Ltd., Gongju-si (KR)

(72) Inventors: Seung Won LEE, Seoul (KR); Byung Hyo YE, Seoul (KR); Jeong Hwan CHOI, Seoul (KR); Byung Sun MO, Seoul (KR)

(73) Assignee: COWAY Co., Ltd., Gongju-si (KR)

(21) Appl. No.: 19/254,269

(22) Filed: Jun. 30, 2025

(30) Foreign Application Priority Data
Jul. 9, 2024 (KR) 10-2024-0090408

(51) Int. Cl. F25D 31/00; C02F 1/00

(52) U.S. Cl. CPC F25D 31/002; C02F 1/001; F25D 2600/04; F25D 2700/12

(57) ABSTRACT

A water purifier comprises: a cooling body configured to contain water; a cold water temperature sensor configured to detect a temperature of the water contained in the cooling body; a cooler configured to cool the water contained in the cooling body; a power supply device configured to supply power to the cooler; and a controller configured to determine whether to drive the cooler based on the temperature of water detected by the cold water temperature sensor, and to control the power supply device and the cooler, wherein the controller controls the power supply device such that, preheating power is supplied to the cooler at the time of turning on the cooler, and operating power greater than the preheating power is supplied to the cooler thereafter.

### TECHNICAL FIELD

The present disclosure relates to a water purifier.

### BACKGROUND

Generally, a water purifier is a device that receives water from a water supply source such as tap water, filters water into purified water, and supplies purified water to a user. Such a water purifier filters water using a filter, and filtered water flows along a flow path provided inside the water purifier and is then discharged to the outside.

Meanwhile, purified water may be supplied directly to the user or may be provided as cold water after being cooled to a predetermined temperature or lower. To achieve this, the interior of the water purifier may include a thermoelectric module for cooling the purified water and a power supply device for supplying power to the thermoelectric module.

In this regard, Korean Patent Application Publication No. 10-2021-0041875 titled “Cold and Hot Water Supply Device of a Cold and Hot Water Purifier Using Thermoelectric Elements” by applicants Go Jeongchan and Go Seongjun (hereinafter referred to as Patent Document 1), discloses a cold and hot water supply device using a thermoelectric element capable of generating cold or hot water in a short time. The controller of Patent Document 1, controls the heat sink temperature disposed on the thermoelectric element to remain relatively lower than the ambient temperature of the water purifier when the hot water mode is selected, so that heat absorption by the heat sink occurs efficiently. In cold water mode, the controller controls the active surface of the thermoelectric element to release heat.

However, it appears that in the cold and hot water supply device of Patent Document 1, when it is determined that power is needed for the thermoelectric element to perform heat absorption or dissipation, the operating power is supplied immediately. If the operating power required to raise or lower the water temperature is supplied directly to the thermoelectric element, electrical damage may occur, and the element is prone to failure.

Also, Korean Patent Application Publication No. 10-2018-0063022 titled “Cold Water Tank and Water Treatment Device Including the Same” by the present applicant (hereinafter referred to as Patent Document 2), discloses a power supply device capable of supplying power to a cooling unit.

However, Patent Document 2 also appears that operating power is directly supplied to the cooling unit when its operation is initiated. Thus, like Patent Document 1, Patent Document 2 presents a problem in that electrical damage may occur to the thermoelectric module, and failure is likely to occur.

In addition, since the power supply device of Patent Document 2 is disposed adjacent to the filter where water is filtered, there is a problem in that heat generated from the power supply device may be transferred to the filter. Furthermore, because the power supply device in Patent Document 2 is located near the flow path through which water flows and near the discharge component from which water is discharged to the outside, there is a risk that the heat generated from the power supply device may be transferred to the flow path and discharge component.

### SUMMARY

The embodiments of the present invention have been devised in view of the above background, and are intended to provide a water purifier in which preheating power is supplied prior to operating power, thereby preventing electrical stress on the cooler.

In addition, the embodiments of the present invention have been devised in view of the above background, and are intended to provide a water purifier that prevents unnecessary power consumption.

Furthermore, the embodiments of the present invention have been devised in view of the above background, and are intended to provide a water purifier in which power is supplied more stably.

In accordance with one embodiment of the present disclosure, a water purifier comprises: a cooling body configured to contain water; a cold water temperature sensor configured to detect a temperature of the water contained in the cooling body; a cooler configured to cool the water contained in the cooling body; a power supply device configured to supply power to the cooler; and a controller configured to determine whether to drive the cooler based on the temperature of water detected by the cold water temperature sensor, and to control the power supply device and the cooler, wherein the controller controls the power supply device such that, preheating power is supplied to the cooler at the time of turning on the cooler, and operating power greater than the preheating power is supplied to the cooler thereafter.

Further, the controller may control the power supply device such that the preheating power is supplied to the cooler for a preset preheating power supply time, and the operating power is supplied to the cooler when the preheating power supply time has elapsed.

Further, the water purifier may further comprise a current sensor configured to measure a current supplied to the cooler, wherein the controller may control the power supply device such that, after the preheating power is supplied to the cooler, when the current measured by the current sensor falls within a preset stable current range, the operating power may be supplied to the cooler.

Further, the controller may control the power supply device such that, initial power may be supplied to the cooler at the time of turning on the cooler, followed by a first intermediate power greater than the initial power, then a second intermediate power greater than the first intermediate power, and finally operating power greater than the second intermediate power, wherein the first intermediate power may be equal to the preheating power, and wherein a difference between the initial power and the first intermediate power may be greater than a difference between the first intermediate power and the operating power.

Further, the controller may control the operation in a cold water maintenance mode when the temperature of the water contained in the cooling body is equal to or lower than a preset cold water maintenance mode determination temperature, and wherein in the cold water maintenance mode, the power supply device may supply power to the cooler at a cold water maintenance mode power that is lower than the operating power.

Further, the first intermediate power may be closer to the operating power than to the average value of the cold water maintenance mode power.

Further, a water purifier may comprise: a cooling body into which water can be introduced; a cold water temperature sensor configured to detect a temperature of the water introduced in the cooling body; a cooler configured to cool the water introduced into the cooling body; a power supply device configured to supply power to the cooler; and a controller configured to determine whether to drive the cooler based on the temperature of water detected by the cold water temperature sensor, and to control the power supply device and the cooler, wherein the controller may control the power supply device such that, preheating power is supplied to the cooler at the time of turning on the cooler, and operating power greater than the preheating power is supplied to the cooler thereafter.

According to one embodiment of the present invention, since operating power is supplied after preheating power, there is an effect of preventing electrical stress on the cooler.

In addition, according to one embodiment of the present invention, since the operating power is supplied after the elapse of a preset preheating power supply time, there is an effect of conveniently determining the timing for supplying the operating power.

Furthermore, according to one embodiment of the present invention, by controlling the system in a cold water maintenance mode based on the cold water temperature, unnecessary power consumption can be prevented.

Additionally, according to one embodiment of the present invention, since the operating power is supplied when the current measured by the current sensor falls within a stable current range, there is an effect of supplying power more stably.

Moreover, according to one embodiment of the present invention, by supplying power in four sequential stages when the cooler starts to operate, there is an effect of achieving more stable power supply.

### BRIEF DESCRIPTION OF THE DRAWINGS

FIG. 1 is a perspective view of a water purifier according to a first embodiment of the present invention.

FIG. 2 is an exploded perspective view of the water purifier shown in FIG. 1.

FIG. 3 is a side view of the water purifier shown in FIG. 1 with the side cover removed.

FIG. 4 is a cross-sectional view taken along line A-A′ of FIG. 1.

FIG. 5 is a graph showing the power supplied to the cooler over time according to the first embodiment of the present invention.

FIG. 6 is a graph showing the power supplied to the cooler over time according to the third embodiment of the present invention.

### DETAILED DESCRIPTION

Hereinafter, specific embodiments for implementing the technical idea of the present disclosure will be described in detail with reference to the drawings.

In addition, in describing the present disclosure, when it is determined that detailed descriptions of known configurations or functions may obscure the gist of the present disclosure, the detailed descriptions will be omitted.

Moreover, it should be understood that when a component is referred to as being ‘connected to’, ‘supported by’, ‘supplied to’, ‘transferred to’, or ‘contacted with’ another component, it may be directly connected to, supported by, supplied to, transferred to, or contacted with another component, but other components may exist between the components.

The terms used in the present specification are only used for describing the specific embodiments and are not intended to limit the present disclosure. Singular expressions include plural expressions unless the context clearly indicates otherwise.

In addition, in the present specification, expressions such as upper, lower, side, etc. are described based on the drawings, and it is made clear in advance that they may be expressed differently if the direction of the object is changed. For the same reason, some components in the accompanying drawings are exaggerated, omitted, or schematically illustrated, and the size of each component does not entirely reflect the actual size.

Further, terms including ordinal numbers, such as first, second, etc., may be used to describe various components, but the components are not limited by these terms. These terms are only used to distinguish one component from another.

The meaning of “including” used in the present specification specifies specific features, regions, integers, steps, operations, elements and/or components, and does not exclude the presence or addition of other specific features, regions, integers, steps, operations, elements, components, and/or groups.

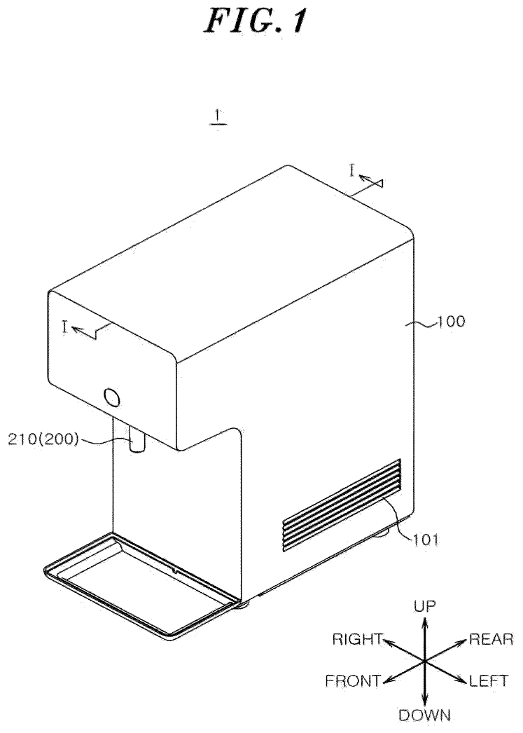

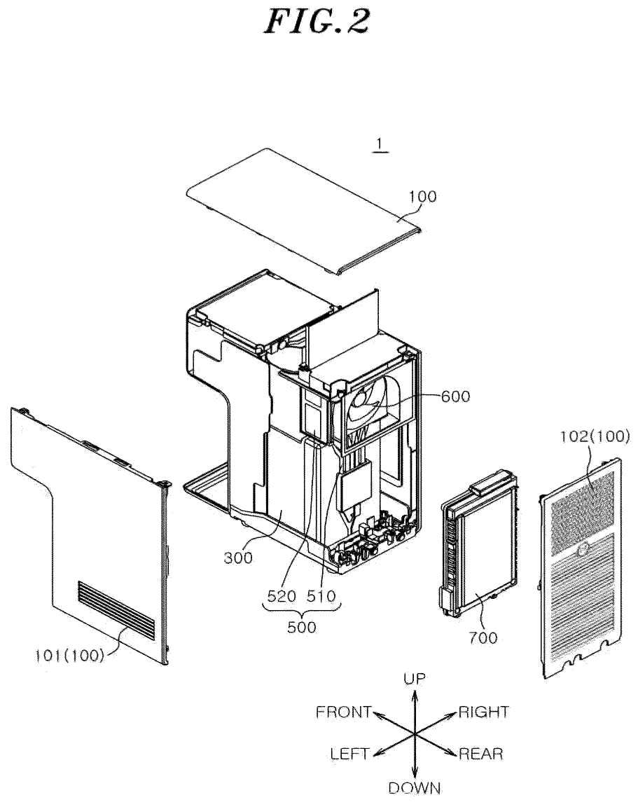

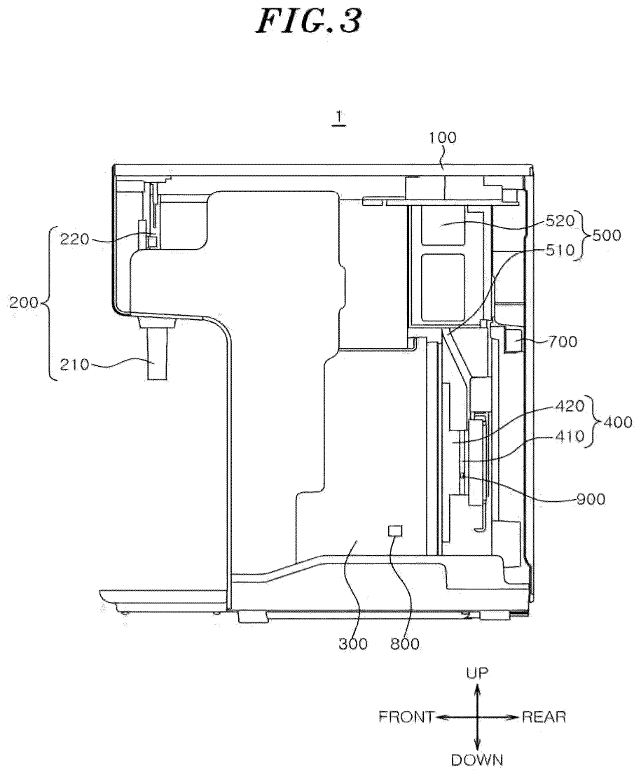

Referring to FIGS. 1 to 4, a water purifier 1 according to an embodiment of the present invention may filter water supplied from an external source and provide clean water to a user. For example, the water purifier 1 may receive water from a water supply source (not shown), such as tap water, and filter the supplied water into clean water. The water purifier 1 may provide clean water to the user by filtering water when a filter (not shown) is installed. The water purifier 1 may include a frame 100, a flow path module 200, a cooling body 300, a cooler 400, a heat dissipation unit 500, a fan unit 600, a power supply device 700, a controller (not shown), a cold water temperature sensor 800, and a current sensor 900.

The frame 100 may support the flow path module 200, cooling body 300, cooler 400, heat dissipation unit 500, fan unit 600, power supply device 700, controller, cold water temperature sensor 800, and current sensor 900. In addition, the frame 100 may provide an internal space for accommodating the flow path module 200, cooling body 300, cooler 400, heat dissipation unit 500, fan unit 600, power supply device 700, controller, cold water temperature sensor 800, and current sensor 900. The frame 100 may have an inlet 101 and an outlet 102.

The inlet 101 may be a through-hole formed in the frame 100 to allow air to flow into the frame 100. The inlet 101 may be formed on a side of the frame 100 and may be provided in plurality. The inlet 101 may be located below the vertical center of the side surface of the frame 100.

The outlet 102 may be a through-hole formed in the frame 100 to discharge air introduced into the frame 100. The outlet 102 may be formed on a rear surface of the frame 100 and may be provided in plurality. The outlet 102 may be located above the vertical center of the rear surface of the frame 100.

The flow path module 200 may guide filtered water from the filter to the outside of the frame 100. The flow path module 200 may be supported by the frame 100 so as to be located at the front portion of the frame 100. Additionally, the flow path module 200 may be detachably mounted to the frame 100 to allow to be replaced. The flow path module 200 may include a water outlet part 210 and a flow path part 220.

The water outlet part 210 may discharge water flowing along the flow path part 220 to the outside. The water outlet part 210 may be positioned on the front of the frame 100, and at least a portion of the water outlet part 210 may be exposed outside the frame 100. The water outlet part 210 may communicate with the flow path part 220.

The flow path part 220 may provide a passage through which water flows. The flow path part 220 may guide the filtered water from the filter to the water outlet part 210. The flow path part 220 may be located at the front portion of the frame 100, and disposed above the water outlet part 210.

The cooling body 300 may provide a space in which the introduced water is cooled to a predetermined temperature or lower. Water introduced into the cooling body 300 may remain temporarily and be cooled. The cooler 400 may be supported by the cooling body 300, and a surface of the cooler 400 may contact an outer surface of the cooling body 300. When one surface of the cooler 400 contacts the outer surface of the cooling body 300, the cold energy generated by the cooler 400 may be transferred to the inside of the cooling body 300.

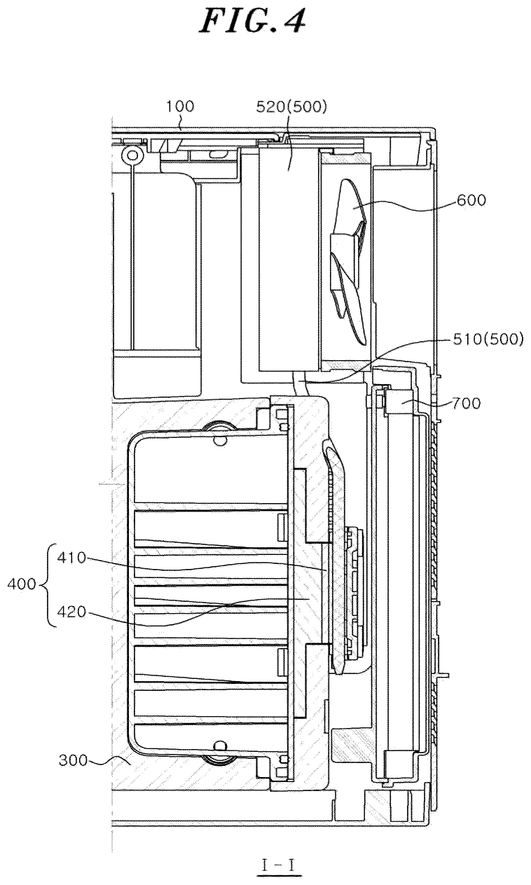

Referring again to FIG. 4, the cooling body 300 may provide a space through which water can flow. For example, the cooling body 300 may be configured in a direct-flow type that provides a path for water to flow. The cooling body 300 may include a plurality of baffles arranged to be offset from each other, and a flow path may be formed by the plurality of baffles. Water introduced from the top of the cooling body 300 may be discharged through the bottom of the cooling body 300. Meanwhile, the flow direction of water flowing along the path formed inside the cooling body 300 may be changed multiple times by the plurality of baffles. The water introduced in the cooling body 300 may be cooled by the cooler 400 while flowing along the baffles. When the cooling body 300 is configured in a direct-flow type, the water may flow zigzag along the baffles, thereby increasing the cooling efficiency, allowing the water to be cooled quickly without stagnating.

However, the scope of the present invention is not limited thereto. As another example, the cooling body 300 may be a reservoir-type water tank that can contain water. When the cooling body 300 is a reservoir-type tank, it may provide a space for accommodating contained water and storing cold water cooled by the cooler 400. For example, the water stored in the cooling body 300 may rise from the bottom to the top as more water is introduced. While rising, the water may be cooled by the cooler 400. When the cooling body 300 is provided as a reservoir-type tank, the cooling body 300 may cool a large amount of water and may be advantageous for maintaining temperature.

As another example, the cooling body 300 may have a pipe shape (not shown) that allows first-in water to be first-out. When the cooling body 300 has a first-in, first-out pipe structure, water flowing through the pipe may be cooled by the cooler 400. Additionally, water introduced into the pipe may be cooled while flowing and then discharged.

The cooler 400 may cool the water contained in or introduced in the cooling body 300 to a predetermined temperature or lower. The cooler 400 may be supported by the cooling body 300 such that one surface of the cooler 400 contacts the outer surface of the cooling body 300. The cooler 400 may be supported on the rear side of the cooling body 300. For example, the front surface of the cooler 400 may contact the rear surface of the cooling body 300. The cooler 400 may cool water without directly contacting it. The cooler 400 may receive power from the power supply device 700, and the power supplied to the cooler 400 may be controlled by the power supply device 700.

Also, the cooler 400 may be an electronic cooling device, allowing the omission of conventional systems such as an evaporator or compressor, thus enabling water to be cooled in a minimal volume. The cooler 400 may include a thermoelectric module 410 and a cold block 420.

One surface of the thermoelectric module 410 may be cooled and the opposite surface may be heated when current flows. The front surface of the thermoelectric module 410 may contact the rear surface of the cold block 420. For example, when the front surface of the thermoelectric module 410 is cooled, the cold energy generated may be transferred to the rear surface of the cooling body 300 via the cold block 420. The rear surface of the thermoelectric module 410 may contact a heat pipe 510 described later, and the heat may be transferred to the heat pipe 510. The thermoelectric module 410 may be miniaturized and generate little to no noise.

The cold block 420 may transfer the cold energy from the thermoelectric module 410 to the cooling body 300. The cold block 420 may be supported by the cooling body 300 so that the front surface of the cold block 420 contacts the rear surface of the cooling body 300. Also, the cold block 420 may support the thermoelectric module 410 so that a rear surface of the cold block 420 contacts the front surface of the thermoelectric module 410. The cold energy generated by the thermoelectric module 410 may be transferred by the cold block 420 to water inside the cooling body 300. For example, the cold block 420 may include a material with high thermal conductivity. Specifically, it may include one or more of aluminum or copper. The cold block 420 may be directly bonded to the cooling body 300 or coupled using fixing members such as screws.

The heat dissipation unit 500 may discharge heat generated by the thermoelectric module 410 to the outside in order to prevent a decrease in cooling efficiency. In addition, the heat dissipation unit 500 may discharge heat generated by the power supply device 700 to the outside. The heat dissipation unit 500 may include a heat pipe 510 and a heat sink 520.

The heat pipe 510 may be disposed on the rear surface of the thermoelectric module 410 and may transfer the heat generated by the thermoelectric module 410 to the heat sink 520. For example, the heat pipe 510 may receive heat from the thermoelectric module 410 via thermal fluid and transfer the received heat to the heat sink 520. A plurality of heat pipes 510 may be provided. When the plurality of heat pipes 510 are provided, the heat transfer area may be increased. The heat pipe 510 may be made of a material with high thermal conductivity.

The heat sink 520 may discharge the heat transferred from the heat pipe 510 to the outside. The heat sink 520 may be disposed above the cooling body 300 and spaced upward from it. The heat sink 520 may be placed above and connected to the heat pipe 510 to receive heat therefrom.

The fan unit 600 may circulate air such that outside air flows into the frame 100 and air inside the frame 100 is discharged to the outside. For example, when the fan unit 600 operates, outside air may be introduced into the frame 100 through the inlet 101, and air inside the frame 100 may be discharged to the outside through the outlet 102.

The fan unit 600 may also provide airflow to the heat sink 520. When the heat sink 520 generates heat, the fan unit 600 may cool the heat sink 520 by circulating air. The fan unit 600 may be disposed on the rear side of the heat sink 520. Intensity of the fan unit 600 may be adjusted based on the operation of the thermoelectric module 410. By providing airflow to the heat sink 520, the fan unit 600 may prevent heat buildup inside the water purifier 1, thereby maintaining cooling performance.

The power supply device 700 may supply power to the thermoelectric module 410 and the fan unit 600. The power supply device 700 may be electrically connected to the thermoelectric module 410 and the fan unit 600. For example, the power supply device 700 may be a switched mode power supply (SMPS). However, this is merely an example, and any known power supply capable of powering the thermoelectric module 410 and fan unit 600 may be used. The power supplied to the thermoelectric module 410 and fan unit 600 may be controlled in strength and may increase in stages as needed. The power supply device 700 may be disposed to the rear side of the cooling body 300 and behind the thermoelectric module 410. Upper portion of the power supply device 700 may support at least one of the heat sink 520 or fan unit 600. The power supply device 700 may also be placed below the heat sink 520 and disposed behind the heat pipe 510.

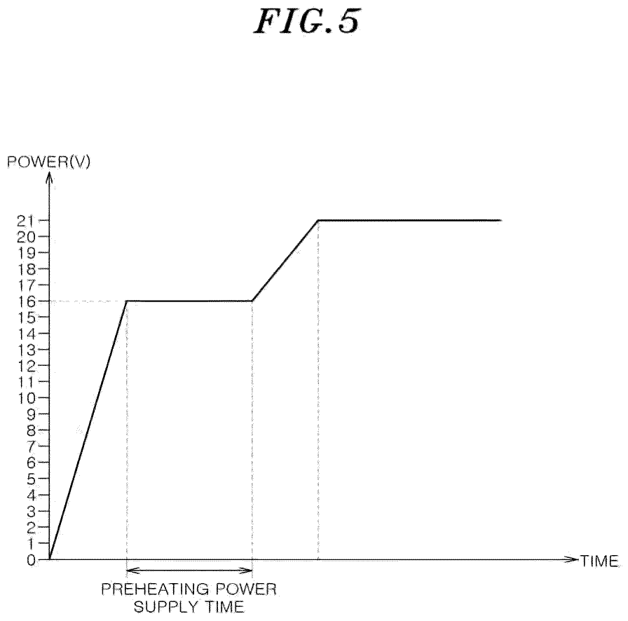

Referring to FIG. 5, the controller may determine whether to drive the cooler 400 based on temperature of the water detected by the cold water temperature sensor 800, and control the power supply device 700 and the cooler 400. The controller may control the power supply device 700 so that a preset preheating power is first supplied to the cooler 400 at the time of turning on the cooler 400. The controller may further control the power supply device 700 to supply an operating power greater than the preheating power after a preset preheating power supply time has elapsed. For example, the preheating power may be 16V, the operating power may be 21V, and the preheating power supply time may be 5 minutes. The controller may control the system so that 16V is first supplied to the cooler 400, and after 5 minutes, 21V is supplied. This staged supply helps to prevent electrical damage to the cooler 400 or minimizes potential electrical damage.

If the temperature of water contained in or introduced in the cooling body 300 is equal to or lower than a preset cold water maintenance mode temperature, the controller may control the power supply device 700 to enter a cold water maintenance mode. In this mode, the power supply device 700 supplies power to the cooler 400 at a cold water maintenance power level, which is lower than the operating power. The controller may determine whether to enter this mode based on the temperature measured by the cold water temperature sensor 800. If the detected temperature is equal to or lower than the cold water maintenance threshold, the water purifier 1 enters the cold water maintenance mode and the cooler 400 receives the cold water maintenance power instead of the operating power from the controller. For example, the cold water maintenance power may be between 5V and 12V More specifically, the power may vary between 5V and 12V depending on the measured temperature in the cold water temperature sensor 800, increasing as the water temperature rises. The controller may be implemented using a computing unit including a microprocessor, which is well known and thus not described further.

The cold water temperature sensor 800 may detect the temperature of water contained in or introduced in the cooling body 300. Based on the measured temperature, the controller determines whether to drive the cooler 400. For example, if the temperature is above a preset activation temperature, the cooler 400 begins operation. If the temperature is below the threshold, the cooler 400 may remain off. The controller may also use this data to decide whether to operate in cold water maintenance mode.

Hereinafter, the operation and effects of the water purifier 1 having the configuration described above will be explained.

The controller may be configured to start supplying preheating power to the cooler 400, and after a preset preheating power supply time has elapsed from the point at which preheating begins, supply operating power to the cooler 400. By supplying operating power after a preset preheating power supply time has elapsed from the point at which preheating begins, electrical damage to the cooler 400 can be prevented or minimized.

When the power supply device 700 is switched to the cold water maintenance mode under control of the controller, and the cooler 400 is supplied with a cold water maintenance power that is lower than the operating power in the cold water maintenance mode, the overall power consumption of the power supply device 700 may be reduced.

In addition, because the power supply device 700 is arranged spaced apart from the water outlet part 210, it is possible to prevent the temperature of water discharged from the outlet from rising due to heat generated by the power supply device 700.

In addition, because the power supply device 700 is spaced from the flow path part 220, it is also possible to prevent the temperature of water flowing through the flow path from increasing due to the heat of the power supply device 700.

In addition, since the power supply device 700 is spaced from the filter, it is possible to prevent a rise in temperature of water entering the filter due to heat generated by the power supply device 700.

Meanwhile, in addition to the above-described configuration, a second embodiment of the water purifier 1 according to the present invention may be provided. In describing the second embodiment, differences from the first embodiment will be mainly described, and the same components and features will be referenced from the first embodiment.

The water purifier 1 may further include a current sensor 900. The current sensor 900 may measure the current supplied to the cooler 400. The controller may determine the current to be supplied to the cooler 400 based on the current measured by the current sensor 900. Specifically, after the power supply device 700 supplies the preheating power to the cooler 400, if the current measured by the current sensor 900 falls within a stable current range, the controller may control the power supply device 700 to supply the operating power to the cooler 400. When the current measured by the current sensor 900 is monitored and determined by the controller to be within the stable range, the controller allows the operating power to be supplied. If the current falls within a preset stable current range, the controller determines that the power supplied to the cooler 400 has stabilized and switches to operating power. The controller may determine that the current is stable if the difference between the maximum and minimum values of current measured by the current sensor 900 during a preset stability judgment time is less than or equal to a preset threshold. For example, the stable current range may be defined as a change in current of less than 300 mA per unit time.

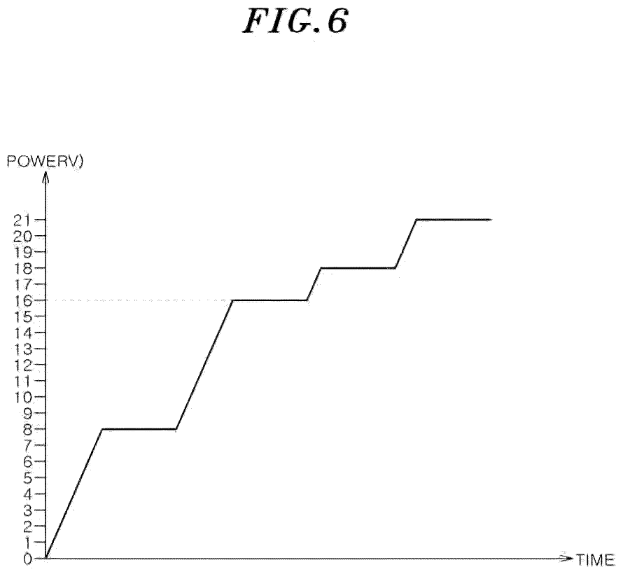

Meanwhile, a third embodiment of the water purifier 1 according to the present invention may also be provided. Referring to FIG. 6, the third embodiment will now be described, focusing on the differences from the previously described embodiments. In describing the third embodiment, differences from the above-described embodiment will be mainly described, and the same components and features will be referenced from the above-described embodiment.

Referring to FIG. 6, the controller may control the power supply device 700 such that when driving of the cooler 400 begins, power is sequentially supplied from a lower level to a higher level. For example, the controller may sequentially supply an initial power, a first intermediate power, a second intermediate power, and an operating power to the cooler 400. The first intermediate power is greater than the initial power, the second intermediate power is greater than the first intermediate power, and the operating power is greater than the second intermediate power. The first intermediate power may be equal to the preheating power. The difference between the initial power and the first intermediate power may be greater than the difference between the first intermediate power and the operating power. Also, the first intermediate power may be closer to the operating power than to the average value of the cold water maintenance power.

For example, the initial power may be 8V, the first intermediate power may be 16V, the second intermediate power may be 18V, and the operating power may be 21V In this example, the 8V difference between the initial and first intermediate power is greater than the 5V difference between the first intermediate and operating power. Also, since the first intermediate power may be 16V, it may be closer to the operating power 21V than to the average of the cold water maintenance power 8.5V. The controller may control the power supply device 700 such that 8V, 16V, 18V, and 21V are sequentially supplied to the cooler 400.

Hereinafter, the operation and effects of the water purifier 1 having the above-described configuration will be explained.

When power is sequentially supplied as initial power, first intermediate power, second intermediate power, and operating power to start driving the cooler 400, the electrical stress applied to the cooler 400 may be reduced. As the power increases in the order of initial, first intermediate, second intermediate, and operating levels, supplying power in increasing stages reduces the burden on the cooler 400 compared to supplying high power from the beginning.

Although the embodiments of the present disclosure have been described as specific embodiments, this is merely an example, and the present disclosure should be construed as having the broadest scope according to the technical idea disclosed herein without being limited thereto. Those skilled in the art may implement a pattern of a shape not indicated herein by combining/substituting the disclosed embodiments, but this also does not deviate from the scope of the present disclosure. In addition, those skilled in the art may easily change or modify the disclosed embodiments based on the present specification, and it is clear that such changes or modifications also fall within the scope of the present disclosure.

What is claimed is:

1. A water purifier comprising:
a cooling body configured to contain water;
a cold water temperature sensor configured to detect a temperature of the water contained in the cooling body;
a cooler configured to cool the water contained in the cooling body;
a power supply device configured to supply power to the cooler; and
a controller configured to determine whether to drive the cooler based on the temperature of water detected by the cold water temperature sensor, and to control the power supply device and the cooler,
wherein the controller controls the power supply device such that, preheating power is supplied to the cooler at the time of turning on the cooler, and operating power greater than the preheating power is supplied to the cooler thereafter.

2. The water purifier of claim 1, wherein the controller controls the power supply device such that the preheating power is supplied to the cooler for a preset preheating power supply time, and the operating power is supplied to the cooler when the preheating power supply time has elapsed.

3. The water purifier of claim 1, further comprising a current sensor configured to measure a current supplied to the cooler,
wherein the controller controls the power supply device such that, after the preheating power is supplied to the cooler, when the current measured by the current sensor falls within a preset stable current range, the operating power is supplied to the cooler.

4. The water purifier of claim 1,
wherein the controller controls the power supply device such that, initial power is supplied to the cooler at the time of turning on the cooler, followed by a first intermediate power greater than the initial power, then a second intermediate power greater than the first intermediate power, and finally operating power greater than the second intermediate power,
wherein the first intermediate power is equal to the preheating power, and
wherein a difference between the initial power and the first intermediate power is greater than a difference between the first intermediate power and the operating power.

5. The water purifier of claim 4,
wherein the controller controls the operation in a cold water maintenance mode when the temperature of the water contained in the cooling body is equal to or lower than a preset cold water maintenance mode determination temperature, and
wherein in the cold water maintenance mode, the power supply device supplies power to the cooler at a cold water maintenance mode power that is lower than the operating power.

6. The water purifier of claim 5, wherein the first intermediate power is closer to the operating power than to the average value of the cold water maintenance mode power.

7. A water purifier comprising:
a cooling body into which water can be introduced;
a cold water temperature sensor configured to detect a temperature of the water introduced in the cooling body;
a cooler configured to cool the water introduced into the cooling body;
a power supply device configured to supply power to the cooler; and
a controller configured to determine whether to drive the cooler based on the temperature of water detected by the cold water temperature sensor, and to control the power supply device and the cooler,
wherein the controller controls the power supply device such that, preheating power is supplied to the cooler at the time of turning on the cooler, and operating power greater than the preheating power is supplied to the cooler thereafter.
